(19) United States
(12) Patent Application Publication
(10) Pub. No.: US 2017/0315548 A1
(43) Pub. Date: Nov. 2, 2017

(54) METHOD OF CONTROLLING A SUBSEA PLATFORM, A SYSTEM AND A COMPUTER PROGRAM PRODUCT

(71) Applicant: Fugro Subsea Services Ltd., Aberdeen (GB)

(72) Inventors: Jason TISDALL, Aberdeen (GB); Jason WILLIAMS, Aberdeen (GB); Steve TETLOW, Aberdeen (GB); Tim RHODES, Aberdeen (GB)

(73) Assignee: Fugro Subsea Services Ltd., Aberdeen (GB)

(21) Appl. No.: 15/526,555

(22) PCT Filed: Nov. 12, 2015
(86) PCT No.: PCT/EP2015/076425

§ 371 Date: May 12, 2017

(30) Foreign Application Priority Data
Nov. 14, 2014 (NL) 2013804

(51) Int. Cl. G05D 1/00; B63G 8/00

(52) U.S. Cl. CPC G05D 1/0038; B63G 2008/005

(57) ABSTRACT

The invention relates to a method of controlling a subsea platform. The method comprises a step of providing a database containing object information of objects identified in an environment wherein the platform is operating, and a step of generating visualization data of said objects. Further, the method comprises a step of receiving camera image data from a camera unit disposed on the subsea platform, and a step of composing an image structure based on the object visualization data and the camera image data. Here, the visualization data of said objects are generated using synthetic models thereof.

The invention relates to a method of controlling a subsea platform.

When operating a subsea platform such as a ROV underwater visibility is limited. Water attenuates light due to absorption, and the water may be turbid causing the ROV's light source to be backscatter. In addition, typical ROV pilot consoles utilize 2-D monitors with limited fields of view making it difficult for the pilot to interpret the ROV's spatial surroundings.

It is an object of the invention to facilitate operation of underwater platforms. Thereto, according to an aspect of the invention, a method of controlling a subsea platform is provided, comprising the steps of providing a database containing object information of objects identified in an environment wherein the platform is operating, generating visualization data of said objects, receiving camera image data from a camera unit disposed on the subsea platform, and composing an image structure based on the object visualization data and the camera image data, wherein the visualization data of said objects are generated using synthetic models thereof.

By using synthetic models for visualizing object data dedicated views for operators of subsea platforms are provided, e.g. by displaying objects as transparent cuboids or by adding synthetic views based on these synthetic models of said object data.

The invention also relates to a system.

Further, the invention relates to a computer program product. A computer program product may comprise a set of computer executable instructions stored on a data carrier, such as but not limited to a flash memory, a CD or a DVD. The set of computer executable instructions, which allow a programmable computer to carry out the method as defined above, may also be available for downloading from a remote server, for example via the Internet, e.g. as an app.

Other advantageous embodiments according to the invention are described in the following claims.

By way of example only, embodiments of the present invention will now be described with reference to the accompanying figures in which

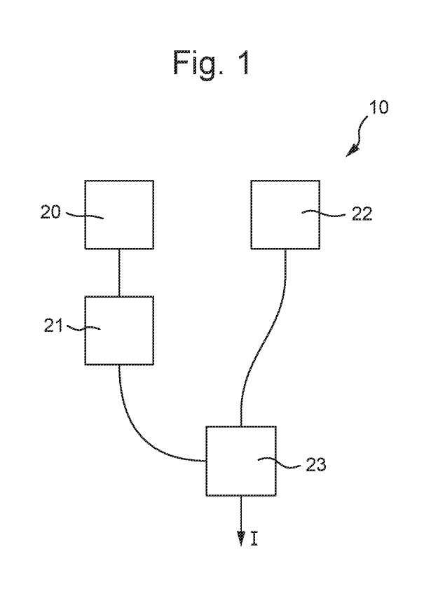

FIG. 1 shows a system according to the invention;

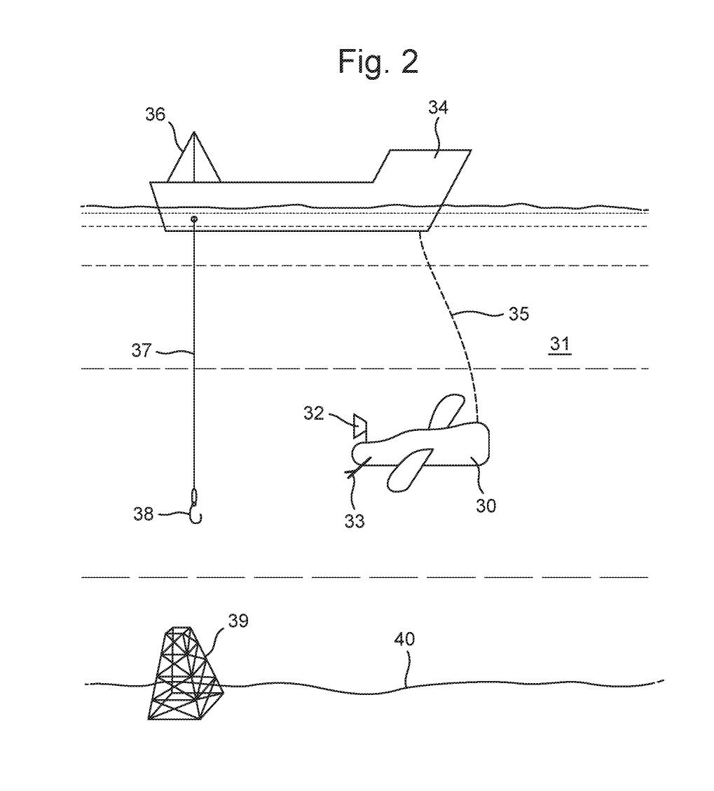

FIG. 2 shows a schematic view of a subsea platform during operation;

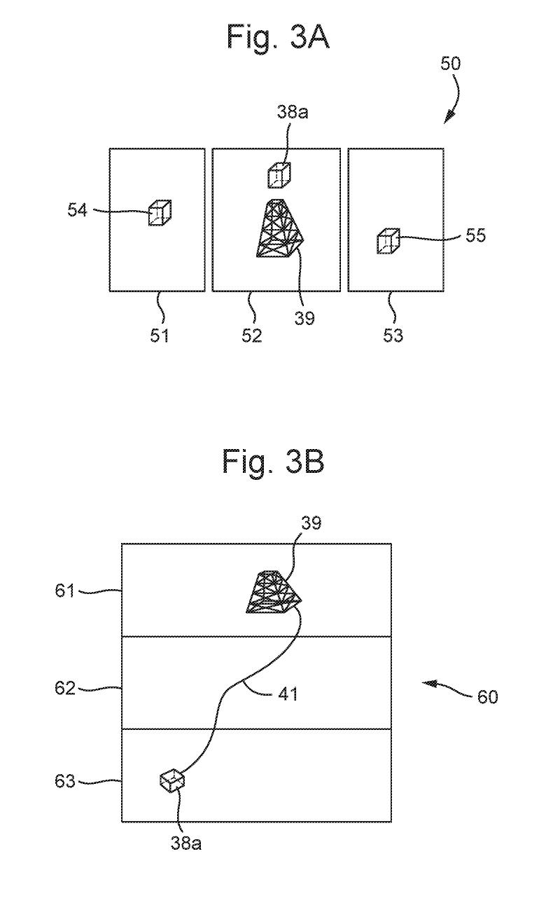

FIG. 3A shows a first display configuration composed using a method according to the invention;

FIG. 3B shows a second display configuration composed using a method according to the invention, and

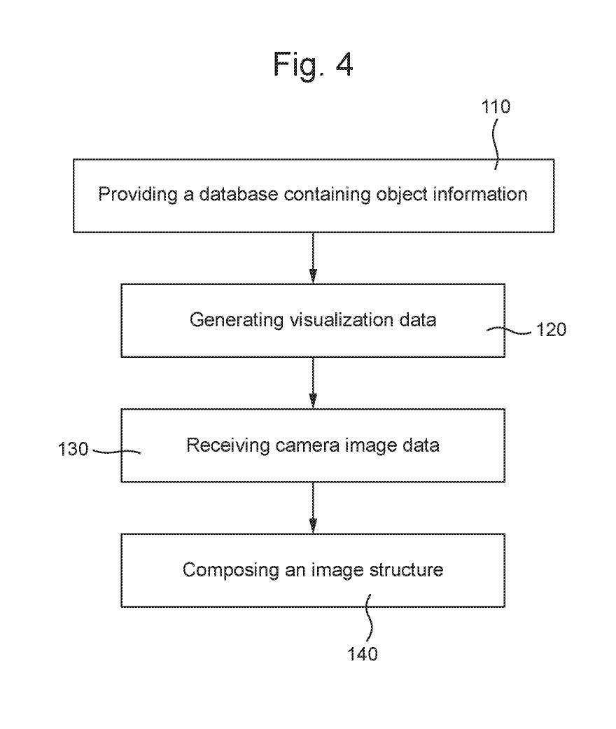

FIG. 4 shows a flow chart of an embodiment of a method according to the invention.

The figures merely illustrate preferred embodiments according to the invention. In the figures, the same reference numbers refer to equal or corresponding parts.

FIG. 1 shows system 10 according to the invention. The system 10 is arranged for controlling a subsea platform such as a remotely operated vehicle ROV or another manned or unmanned subsea vessel. Thereto, the system 10 comprises a database 20 containing object information of objects identified in an environment wherein the subsea platform is operating. Further, the system 10 includes graphical models 21 for generating visualization data of said objects. In addition, the system 10 includes a receiving unit 22 receiving camera image data from a camera unit disposed on the subsea platform. The system 10 also comprises a processor 23 composing an image structure I based on the object visualization data and the camera image data. Here, the visualization data of said objects are generated using synthetic models thereof. Optionally, the processor is further arranged for performing physics simulation for estimating locations of identified objects.

FIG. 2 shows a schematic view of a subsea platform 30 during operation. The subsea platform 30 is a ROV travelling in a subsea environment 31. The ROV is provided with a camera 32 and a work tool 33. Further, the ROV is connected to a surface vessel 34 via a cable 35, e.g. for transmitting data signals. Alternatively, the subsea platform is an autonomous vehicle. Further, the subsea platform may have a wireless connection with a surface vessel, e.g. using an electromagnetic or sonic data transmission channel, possibly depending on local conditions in the subsea environment 31. The surface vessel 34 is also provided with a hoisting device 36 and a hoisting cable 37 carrying a further tool, in the shown embodiment a hook 38. The ROV may be operated for performing activities at a mechanical structure 39 at the sea bottom 40.

In order to facilitate operation of the ROV an imaging technique is applied as described below. During operation, the database 20 of the system 10 is used for providing information of the environment 31 wherein the ROV is operating. The database 20 contains object information of objects such as the hook 38 identified in said environment 31. Objects around the ROV can be identified using a variety of sensors and/or other sources of information. In principle, the static or dynamic position of these identified objects relative to the platform can in principle be determined using such information. As an example, software algorithms can be applied to process one or more camera signals captured from the platform 30. In this process, knowledge of the expected subsea topology, known objects, recognisable landmarks, locations of cameras relative to a frame of reference and other factors may be used. As a further example, object information may be retrieved from sonar return data, position sensor data, magnetic data, radioactive data, seismic data, material property data, map data, engineering data, plans and procedural data, force data, acceleration data, mass data, static data, dynamic data. In addition there is a time based history of all data.

Generally, also the ROV has a position and orientation in the environment 31 such as a sea or an ocean. The position and orientation of the ROV can be measured using various sensors.

From said objection information visualization data is generated, using synthetic models of said objects. As an example, three-dimensional graphical models “3D Models” of the subsea world are applied containing rich data including but not limited to physical properties, dimensional properties, location properties, and their display properties. The display properties allow graphical models to be conditioned so that they are suitable for a range of different display applications including 3D rendered views, augmented reality “AR” overlay views, combined camera and rendered views and other views. As an alternative, a 3D transparent cuboid bounding box can be displayed so that a user's view is not blocked, while optionally providing the user with information about size, orientation and/or distance of the object.

Alternate models are 2D images or text or symbols “2D models” and can be displayed and manipulated in similar ways as “3D Models”.

Generally, the platform 30 is dynamic and mobile. Further, the platform 30 may carry tools 33 such as a manipulator or custom tooling as shown in FIG. 2. The tools 33 themselves are also dynamic. Control signals for the tools 33 may be augmented by object location knowledge to remove unwanted or undesirable motion and so simplify application of the tools 33. The tools 33 may also be controlled using paths defined within the software, or by arbitrary control interfaces that allow motion in alternate joint or co-ordinate spaces.

Any additional information about the environment wherein the ROV is operating in provided to a ROV pilot or operator may increase the safety and success of a subsea mission. Moreover it is advantageous to provide this information in such a way that it can be processed by the ROV pilot while simultaneously performing the task of piloting the ROV.

During operation, camera image data is received from the camera unit 32 disposed on the ROV. Then, an image structure is composed based on the object visualization data and the camera image data.

FIG. 3A shows a first display configuration 50 composed using a method according to the invention. In the display configuration 50 the hook 38 as well as the mechanical structure 39 is visible. The mechanical structure 39 is shown as captured by the camera 32 on the ROV. However, the hook 38 is shown as a cuboid 38a. Here, an augmented reality view is composed by superposing a live image of the camera with the cuboid 38a of the hook 38. Preferably, the cuboid 38a is transparent so that the user's view is not blocked.

The augmented reality view shows a cuboid at an object location instead of a graphical overlay. In this way the pilot can still view the actual object. Such techniques are especially useful in low visibility environments. FIG. 3A shows the cuboid overlay 38a on the live image of the camera 32.

Generally, a cuboid is a convex polyhedron bounded by six quadrilateral faces. Preferably, each of the faces is a rectangle.

Preferably, object cuboids can be enabled and disabled. In this way the augmented reality world does not become cluttered. Further, object cuboids may include information about the object such as dimensions, type of object or other metadata. The visualization of the object cuboids may be arranged such that more information becomes visible when the ROV approaches the respective object.

Advantageously, the cuboid is displayed using either a chromakey or lumakey algorithm in which specific colours or luminance thresholds may be masked out of the augmented image so that those parts do not appear on the camera view.

In a specific embodiment, the image structure includes a plan view displaying the position of the platform relative to the identified objects. As an example, the plan view is available in a corner of the augmented reality view. In this way the ROV pilot can see the ROV's position relative to other objects. Optionally, the plan view rotates with the view. By providing a rotating map aligned with the orientation of the ROV, a strong sense of the ROV's location in the environment can be obtained, e.g. applying a forward-up orientation.

Optionally, the image structure includes an augmented reality view including a live view based on the camera image data and object visualization data, wherein the image structure further includes a synthetic view adjacent to the augmented reality view, the synthetic view being based on synthetic models of identified objects, preferably together with a synthetic view of the environment and the seabed. In the first display configuration 50 shown in FIG. 3A, three display portions are shown, e.g. a left-hand side display portion 51, a central display portion 52 and a right-hand side display portion 53. The above-mentioned augmented reality view is displayed in the central display portion 52. Further, the above-mentioned synthetic views are displayed in the left-hand side and the right-hand side display portions 51, 53. The synthetic views 51, 53 each contain further object cuboids 54, 55.

Synthetic views can be based on the ROV's positional information, positional information of objects and environment information. The synthetic viewing angle may correspond to that of the ROV camera or may be chosen by an operator, pilot or navigator viewing the display configuration 50. Here, real and synthetic views may be combined in a continuous scene i.e. you look ahead and see the camera view with AR overlay. As you turn your head out of the range of the real camera, the view continues but is now synthetic.

Advantageously, a live view in the image structure is distorted so as to simulate a synthetic point of view. Then, the viewpoint can be arbitrarily moved by distorting the live camera part of the image to be appropriately oriented to represent the original view. In this way, the operator can move out to a more convenient remote orientation but still see at a glance where a return to the live camera view will place his viewpoint in the world.

FIG. 3B shows a second display configuration 60 composed using a method according to the invention. Again, the display configuration 60 includes three display portions, viz. a top display portion 61, a central display portion 62 and a bottom display portion 63. The display configuration has a non-linear scale on the vertical axis. In the shown embodiment, the scale is logarithmic so that the display configuration may show details of objects in the close neighbourhood of the ROV as well as a general overview of the environment on a larger scale. Here, the top display portion 61 shows a view covering distances from 1 km-10 km, the central display portion shows a view covering distances from 100 m-1 km, and the bottom view 63 shows a view covering distances to 100 m. The display portions 61, 62, 63 display subsequent distance ranges so that the vertical axis is continuous, however at a logarithmic scale, thus simulating a birds-eye view. In the embodiment shown in FIG. 3B a cuboid object 38a is displayed in the bottom display portion 63 while a mechanical structure 39 is shown in the top display portion 61. The display configuration further shows a pipelay path 41 extending from the top display portion 61 via the central display portion 62 to the bottom display portion 63, between the cuboid object 38a and the mechanical structure 39. It is noted that, in principle, also another non-linear vertical scale can be chosen. Preferably, objects have been scaled based on their location.

In an alternative approach, the image portions 61, 62, 63 represent images having the same orientation but a different synthetic point of view, thereby also simulating a birds-eye view. As an additional overlay on the camera view, or as a separate view on a different screen, a linear or logarithmic scale can be applied on each image portion. Then, important features may thus be shown at appropriate size enabling highlighting of detailed near features together with more distant features in a single meaningful display configuration 60. As an example, the top display portion 61 may show a 0-100 m overlaid, the central display portion 62 may show a 0 km-1 km overlaid, and the bottom display portion 63 may show a 0 km-10 km overlaid, thereby providing scaled display views showing objects in a close view, in a more removed view and in a remote view 39c.

Optionally, the image structure includes a downwardly oriented view, e.g. relative to the ROV's perspective. In this way pilots can verify that the ROV is not interfering with objects positioned under the ROV. The downwardly oriented view may be part of a continuous synthetic view as explained above or could be a separate view.

Combined applications are also possible, for example automatic station keeping. Positional feedback may also be used to change ROV tool paths. Also, camera image data may be compensated for movements of the ROV. In this way the tool path can compensate for ROV motion. For example, if the tool must be extracted in a straight line. Further, movements of an actuator 33 controlled by the ROV may be compensated for movements of the ROV.

In a specific embodiment, the image structure includes a synthetic view of a tool operated by an operator controlled interface, wherein the position and orientation of the tool in the synthetic view is based on manipulation data generated on the interface such as a sensor array on a glove.

Further, information of a previous operation and/or inspection may be included in the image structure. This information could result in event triggered actions, for example semi/fully automated repairs may occur. This improves asset integrity. As an example, the image structure includes overlay information from a previous operation and/or inspection. This would allow a pilot to view how the scene diverges from a previous inspection. For example, an object may have shifted or changed since the previous inspection.

Advantageously, the object information includes actual location information of tools applied by the subsea platform, optionally by simulating a tool location based on remote parameter values such as a length of a hoisting cable and/or direction and magnitude of sea current. Live positioning of objects in the environment, such as a device being lowered from the surface vessel via a crane, may thus also be combined in the image structure without using beacon sensors. So not just static objects but also dynamic objects, and simulated ropes, cables or risers may be selected as important and overlaid in a geographically correct location in the pilots view. Such objects include, but are not limited to, ROVs, subsea compressors, BOPs, mats, spool pieces, tethers, umbilicals, manipulators and tools.

Generally, the location of the subsea platform and/or a camera on the subsea platform is measured using physical sensors. Also, the location of an identified object can be measured using physical sensors such as sonar.

However, the location of an identified object can also be estimated from a simulation model such as a static or real-time physics simulation rather than from live sensor data.

The joining of virtual reality and live camera views in the same contiguous viewing space is referred to as Mixed Reality “MR”, and when combined with additional useful data overlays is referred to as Mediated Mixed Reality “MMR”.

Where MRR is presented to the operator via a headset, then it is referred to as Immersive Mediated Mixed Reality “IMMR”. In this case, the traditional manual controls are no longer visible to the operator. Instead, virtual interfaces may be used to allow real tools and platforms to be controlled by an operator using appropriate combinations of the above technologies.

The MMR technique displays a range of processed outcomes to provide important meta-data for the operator. This may include virtual tool locations, virtual depth sensors, and/or relative position data in various frames of reference such as a global frame, a tool frame, a local frame, a polar frame or a Cartesian frame.

FIG. 4 shows a flow chart of an embodiment of a method according to the invention. The method is used for controlling a subsea platform. The method comprises a step of providing 110 a database containing object information of objects identified in an environment wherein the platform is operating, a step of generating 120 visualization data of said objects, a step of receiving 130 camera image data from a camera unit disposed on the subsea platform, and a step of composing 140 an image structure based on the object visualization data and the camera image data, wherein the visualization data of said objects are generated using synthetic models thereof. As described above, positioning data of objects can be processed, either from sensors measuring object locations or as a result of physics simulation estimating the respective locations of the objects. The method of controlling a subsea platform can be performed using dedicated hardware structures, such as FPGA and/or ASIC components. Otherwise, the method can also at least partially be performed using a computer program product comprising instructions for causing a processor of a computer system or a control unit to perform the above described steps of the method according to the invention, or at least the step of composing an image structure based on the object visualization data and the camera image data. All steps can in principle be performed on a single processor. However, it is noted that at least one step can be performed on a separate processor. A processor can be loaded with a specific software module. Dedicated software modules can be provided, e.g. from the Internet.

The invention is not restricted to the embodiments described herein. It will be understood that many variants are possible.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A method of controlling a subsea platform, the method comprising the steps of:
providing a database containing object information of objects identified in an environment wherein the platform is operating;
generating visualization data of said objects;
receiving camera image data from a camera unit disposed on the subsea platform, and
composing an image structure based on the object visualization data and the camera image data, wherein the visualization data of said objects are generated using synthetic models thereof.

2. The method according to claim 1, wherein the synthetic model of an identified object is a transparent cuboid representing said object as an overlay on a live view based on the camera image data.

3. The method according to claim 2, wherein the cuboid can be disabled and enabled.

4. The method according to claim 12, wherein the cuboid is displayed using a chromakey algorithm or a lumakey algorithm.

5. The method according to claim 1, wherein the image structure includes a plan view displaying the position of the platform relative to the identified objects.

6. The method according to claim 1, wherein the image structure includes an augmented reality view including a live view based on the camera image data and objection visualization data, and wherein the image structure further includes a synthetic view adjacent to the augmented reality view, the synthetic view being based on synthetic models of identified objects.

7. The method according to claim 6, wherein a live view in the image structure is distorted so as to simulate a synthetic point of view.

8. The method according to claim 1, wherein the image structure includes a rotating map aligning with the orientation of the platform.

9. The method according to claim 1, wherein the image structure includes an image having a non-linear vertical axis, preferably a logarithmic vertical axis.

10. The method according to claim 1, wherein the image structure includes images having the same orientation but a different synthetic point of view.

11. The method according to claim 1, wherein the image structure includes a downwardly oriented view.

12. The method according to claim 1, wherein the image structure is displayed to an operator or navigator of the subsea platform.

13. The method according to claim 1, wherein the image structure includes a synthetic view of a tool operated by an operator controlled interface, wherein the position and orientation of the tool in the synthetic view is based on manipulation data generated on the interface.

14. The method according to claim 1, wherein information of a previous operation and/or inspection is included in the image structure.

15. The method according to claim 1, wherein the image structure includes overlay information from a previous operation and/or inspection.

16. The method according to claim 1, wherein the object information includes actual location information of tools applied by the subsea platform, optionally by simulating a tool location based on remote parameter values such as a length of a hoisting cable.

17. The method according to claim 1, wherein the location of the subsea platform and/or a camera on the subsea platform is measured using physical sensors.

18. The method according to claim 1, wherein the location of an identified object is estimated from a simulation model.

19. The method according to claim 1, wherein camera image data is compensated for movements of the subsea platform.

20. The method according to claim 1, wherein movements of an actuator controlled by the platform are compensated for movements of the subsea platform.

21. A system for controlling a subsea platform, comprising:
a database containing object information of objects identified in an environment wherein the platform is operating;
graphical models for generating visualization data of said objects;
a receiving unit configured to receive camera image data from a camera unit disposed on the subsea platform;
a processor composing an image structure based on the object visualization data and the camera image data,
wherein the visualization data of said objects are generated using synthetic models thereof.

22. A computer program product for controlling a subsea platform, the computer program product comprising computer readable code for causing a processor to perform the steps of:
provide a database containing object information of objects identified in an environment wherein the platform is operating;
generate visualization data of said objects;
receive camera image data from a camera unit disposed on the subsea platform, and
compose an image structure based on the object visualization data and the camera image data,
wherein the visualization data of said objects are generated using synthetic models thereof.
